(19) United States
(12) Patent Application Publication
(10) Pub. No.: US 2010/0070164 A1
(43) Pub. Date: Mar. 18, 2010

(54) NAVIGATION APPARATUS

(76) Inventor: Hiroshi Machino, Tokyo (JP)

Correspondence Address: BIRCH STEWART KOLASCH & BIRCH, PO BOX 747, FALLS CHURCH, VA, 22040-0747, US

(21) Appl. No.: 12/513,393

(22) PCT Filed: Oct. 3, 2007
(86) PCT No.: PCT/JP2007/069381

§ 371 Date: May 4, 2009

(30) Foreign Application Priority Data
Dec. 4, 2006 (JP) 2006-327393

(51) Int. Cl. G01C 21/36

(52) U.S. Cl. 701/201

(57) ABSTRACT

A navigation apparatus includes a map data acquiring means 11a, 11, 12, and 5 for acquiring map data including car pool lane data, a current position determining means 13, 14, 15, and 10 for determining a current position, and a display unit 2 for generating and displaying a map of an area surrounding the current position determined by the current position determining means on the basis of the map data acquired by the map data acquiring means. The navigation apparatus further includes a control unit 10 for, when moving close to a predetermined location during travel along a road, on a basis of the car pool lane data included in the map data acquired by the map data acquiring means, automatically causing the display unit to display a detailed drawing showing lane information and a car pool lane in distinction from other lanes while enlarging the lane information and the car pool lane.

### FIELD OF THE INVENTION

The present invention relates to a navigation apparatus which displays information about a car pool lane which is disposed on a highway, an expressway, or the like which exists in the traveling direction of a vehicle, as well as with the map, on a display unit.

### BACKGROUND OF THE INVENTION

A conventional navigation apparatus displays the current position of a vehicle which is determined by a vehicle position determining unit on a digital map (simply referred to as a “map” from here on) displayed on a display unit while superimposing the current position on the map. Furthermore, the conventional navigation apparatus searches for a recommended route from the current position of the vehicle which is determined by the vehicle position determining unit to a destination inputted via an input unit, and displays the recommended route on the map. The conventional navigation apparatus then carries out a route guidance of the recommended route on the basis of the shapes of road links read from a recording medium.

By the way, as controlled-access roads, there exist not only a road in which travel of all the vehicles is restricted, but also a road in where travel of vehicles is restricted according the conditions of the vehicles. For example, a car pool lane (Car Pool Lane) which is adopted by a road system mainly seen in big cities of North American is an example. A car pool lane is also called an HOV lane (High Occupancy Vehicle Lane), and is a lane along which, for example, only vehicles in each of which two or more persons are riding are granted to travel. For example, a lane which is also provided on a highway, a lane which is a shortcut of an interchange, and so on are known as car pool lanes. A road system which adopts such a car pool lane provides users with a preferential treatment that makes it possible to arrive at the destination in a shorter time when they travel along a car pool lane so as to prod users to share a vehicle with one or more persons, thereby reducing the traffic as a whole and therefore reducing traffic congestions.

As a technology relevant to such a car pool lane, patent reference 1 discloses a vehicle-mounted navigation apparatus which searches for a recommended route in consideration of the number of passengers. This vehicle-mounted navigation apparatus has a storage unit for storing map data including link data about each link which constructs a road on a map. As for a car pool link on which restrictions of prohibiting a vehicle which are not occupied by two or more persons from traveling are imposed, the vehicle-mounted navigation apparatus uses link data including information showing that such restrictions are imposed on the car pool link to search for a recommended route from the place of departure to the destination. Furthermore, when a car pool link is included in a constitution link which constructs the recommended route, the vehicle-mounted navigation apparatus receives an input of the number of passengers, and searches for a recommended route from the place of departure to the destination by using the link data to exclude links along which the vehicle cannot travel because the received number of passengers does not meet a certain criterion.

Patent reference 2 discloses a route searching device which can perform a search for a route in consideration of the conditions of a vehicle through an easy operation. This route searching device is provided with a map data acquiring unit for acquiring map data defined by nodes and road links, a route searching unit for searching for a route to a destination before the conditions of the vehicle are set up, taking into consideration a road link corresponding to a particular road for which whether or not the vehicle can travel according to the conditions of the vehicle is determined, the road link being included in the map data acquired by the map data acquiring unit, and an output unit for outputting the route searched for by the route searching unit.
[Patent reference 1] JP,2005-061988,A
[Patent reference 2] JP,2005-083758,A

For users of navigation apparatuses, car pool lanes in which travel of vehicles is restricted by a law are necessary to travel along a congested highway safely in a shorter time. However, conventional navigation apparatuses do not produce any special display about car pool lanes, but sets up a destination after a “use” setting is made as to car pool lanes, and, as a result of performing a search for a route on the basis of this setting, if a car pool lane exists in the route which has been searched for, simply displays the route. A problem is therefore that the user does not know which one of a plurality of lanes is a car pool lane, what kind of vehicle type can travel along a car pool lane, in which time zone the vehicle can travel along a car pool lane, etc.

When no route search is carried out, the user cannot know existence of any car pool lane, and therefore cannot set up the position of a car pool lane beforehand and cannot drive the vehicle while recognizing existence of a car pool lane. A problem is therefore that the user cannot utilize car pool lanes sufficiently.

The present invention is made in order to solve the above-mentioned problems, and it is therefore an object of the present invention to provide a navigation apparatus which can make the user recognize appropriate information about a car pool lane.

### DISCLOSURE OF THE INVENTION

In accordance with the present invention, there is provided a navigation apparatus including: a map data acquiring means for acquiring map data including car pool lane data, a current position determining means for determining a current position, and a display unit for generating and displaying a map of an area surrounding the current position determined by the current position determining means on a basis of the map data acquired by the map data acquiring means, in which the navigation apparatus includes a control unit for, when judging from the car pool lane data included in the map data that a car pool lane exists on a road in a traveling direction, the road being detected on a basis of both the map data acquired by the map data acquiring means and the current position determined by the current position determining means, causing the display unit to display information about the car pool lane.

Because when judging that a car pool lane exists on a road in the traveling direction on the basis of the car pool lane data, the navigation apparatus in accordance with the present invention displays information about the car pool lane on the display unit regardless of whether the navigation apparatus has performed a route search, the navigation apparatus in accordance with the present invention enables the user to recognize the appropriate information about the car pool lane. Therefore, the user can acquire the information about the car pool lane before the vehicle enters the car pool lane or at an earlier time than when the user will recognize a sign indicating the car pool lane visually. As a result, the user can do safe driving more quickly while keeping calm.

### BRIEF DESCRIPTION OF THE FIGURES

FIG. 1 is a block diagram showing the structure of a navigation apparatus in accordance with Embodiment 1 of the present invention;

FIG. 2 is a flow chart showing the operation of the navigation apparatus in accordance with Embodiment 1 of the present invention;

FIG. 3 is a view showing an example of a destination setup screen which is displayed in the navigation apparatus in accordance with Embodiment 1 of the present invention;

FIG. 4 is a view showing an example of a search condition setup screen which is displayed in the navigation apparatus in accordance with Embodiment 1 of the present invention; and

FIG. 5 is a view showing an example of display of information about a car pool lane which is displayed in the navigation apparatus in accordance with Embodiment 1 of the present invention.

### PREFERRED EMBODIMENTS OF THE INVENTION

Hereafter, in order to explain this invention in greater detail, the preferred embodiments which implement the present invention will be described with reference to the accompanying drawings.

### Embodiment 1

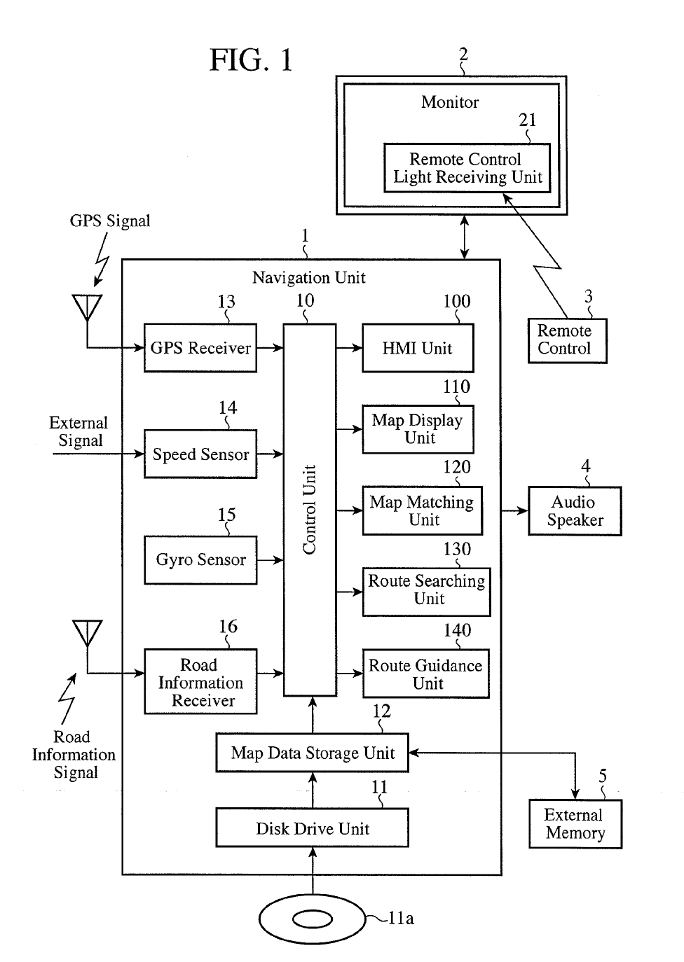

FIG. 1 is a block diagram showing the structure of a navigation apparatus in accordance with Embodiment 1 of the present invention. This navigation apparatus is comprised of a navigation unit 1, a monitor 2 for map display, a remote controller (abbreviated as a “remote control” from here on) 3, an audio speaker 4, and an external memory 5.

The navigation unit 1 forms the heart of the navigation apparatus, and carries out processes, such as a map display, a route search, a route display, and a route guidance. Especially, an output of information about a car pool lane (a display and an output by voice), which is a feature of the present invention, is also performed though control by this navigation unit 1. The details of this navigation unit 1 will be mentioned below.

The monitor 2 corresponds to a display unit of the present invention. The monitor 2 is comprised of, for example, an LCD (Liquid Crystal Display), and displays a map, a vehicle position mark, guidance information about a route to a destination, and various other messages according to display data sent thereto from the navigation unit 1. A remote control light receiving unit 21 is disposed in this monitor 2. The remote control light receiving unit 21 receives a light signal sent thereto from the remote control 3, and sends the light signal to the navigation unit 1 via the monitor 2.

The remote control 3 corresponds to an input unit of the present invention, and is used by the user to scroll a map, and to answer a message for urging the user to do a certain operation which is outputted from the monitor 2 or the audio speaker 4. Instead of the remote control 3 or together with the remote control 3, a touch panel can be disposed for enabling the user to directly touch a touch sensor mounted on the screen of the monitor 2 to input various pieces of information.

The audio speaker 4 corresponds to a voice output device of the present invention, and outputs, by voice, a route guidance message including a guidance about car pool lanes according to audio data sent thereto from the navigation unit 1.

The external memory 5 is optional, and is comprised of, for example, an HDD (Hard Disk Drive). Map data which are similar to map data stored in a recording medium 11a inserted into a disk drive unit 11 which will be mentioned below and including car pool lane data are stored in this external memory 5.

Next, the details of the navigation unit 1 will be explained. The navigation unit 1 is comprised of a control unit 10, the disk drive unit 11, a map data storage unit 12, a GPS (Global Positioning System) receiver 13, a speed sensor 14, a gyro sensor 15, a road information receiver 16, a human-machine interface (abbreviated as an “HMI” from here on) unit 100, a map display unit 110, a map matching unit 120, a route searching unit 130, and a route guidance unit 140.

The control unit 10 is comprised of, for example, a microcomputer, and controls the whole of this navigation unit 1. The HMI unit 100, the map display unit 110, the map matching unit 120, the route searching unit 130, and the route guidance unit 140 are comprised of an application program which operates under the control of this microcomputer.

When the recording medium 11a, such as a DVD (Digital Versatile Disc) or a CD (Compact Disc), in which a map database including map data is stored is inserted thereinto, the disk drive unit 11 plays back a content recorded in the recording medium. The map data are defined by nodes, road links, etc., and include link information, such as intersection construction links, destination area data, car pool lane data, and road number data. The map data played back by this disk drive unit 11 are sent to the map data storage unit 12.

Car pool lane data include lane information (the position of a car pool lane in all lanes), information about the types of vehicles which can use the car pool lane (e.g., a general vehicle, a bus, a truck, an emergency vehicle, a hybrid vehicle, a motorcycle, and so on), information about the number of passengers which is required of the user to use the car pool lane, information about dates or days of the week on which vehicles can use the car pool lane, and a time zone in which vehicles can use the carpool lane, information about the toll fee of using the car pool lane, etc.

The map data storage unit 12 temporarily stores the map data sent thereto from the disk drive unit 11 or the external memory 5. A map data acquiring means in accordance with the present invention is comprised of either the disk drive unit 11 or the external memory 5, and the map data storage unit 12. The map data stored in this map data storage unit 12 are used for display of information about a car pool lane, which will be mentioned below, a map, roads, various icons, other information, etc.

The GPS receiver 13 detects the current position of the vehicle on the basis of GPS signals from GPS satellites which are received via an antenna. Current position data showing the current position of the vehicle detected by this GPS receiver 13 are sent to the control unit 10. The speed sensor 14 detects the traveling speed of the vehicle on the basis of an external signal sent thereto from the vehicle in which this navigation apparatus is mounted. Speed data showing the traveling speed of the vehicle detected by this speed sensor 14 are sent to the control unit 10.

The gyro sensor 15 detects the traveling direction of the vehicle. Direction data showing the traveling direction of the vehicle detected by this gyro sensor 15 are sent to the control unit 10. The control unit 10 detects the current position of the vehicle with self-contained navigation on the basis of the speed data sent thereto from the speed sensor 14 and the direction data sent thereto from the gyro sensor 15. Because the navigation apparatus can detect the current position of the vehicle with self-contained navigation even if the navigation apparatus cannot detect the current position of the vehicle using the GPS receiver 13 when, for example, the vehicle is running through a tunnel, the navigation apparatus can always detect the current position of the vehicle correctly. A current position determining means in accordance with the present invention is comprised of the GPS receiver 13, the speed sensor 14, the gyro sensor 15, and the control unit 10 which processes data sent thereto from these components.

The road information receiver 16 receives a road information signal transmitted from, for example, an external road traffic data communications system. The road information signal received by this road information receiver 16 is sent to the control unit 10. The control unit 10 generates a message showing congestion information about congestion on roads on the basis of the road information signal received from the road information receiver 16, and notifies the message to the user via the monitor 2 and the audio speaker 4.

Under the control of the control unit 10, the HMI unit 100 processes either a command which is generated when the user manipulates a not-shown control panel or a command sent thereto from the remote control 3 via the monitor 2 including the remote control light receiving unit 21. This HMI unit 100 carries out communications between the navigation apparatus and the user.

The map display unit 110 generates drawing data for making the monitor 2 display a map, an intersection guidance figure, information about a car pool lane, a telop for notifying various pieces of information to the user, etc. under the control of the control unit 10. The drawing data generated by this map display unit 110 are sent to the monitor 2, so that a map, a intersection guidance figure, information about a car pool lane, etc. are displayed on the screen of the monitor 2.

Under the control of the control unit 10, the map matching unit 120 matches the vehicle position which is generated on the basis of either the current position data from the GPS receiver 13 or the current position data generated from the speed data sent thereto from the speed sensor 14 and the direction data sent thereto from the gyro sensor 15 to the map shown by the map data read from the map data storage unit 12 so as to form a vehicle position mark on the map.

Under the control of the control unit 10, the route searching unit 130 searches for a recommended route from the current position of the vehicle to the destination which the user has set up by using the remote control 3 according to search conditions which the user has set up by using the remote control 3. This route searching unit 130 can perform both a search for a route which enables use of car pool lanes and a search for a route which disables use of car pool lanes.

Irrespective of whether the vehicle travels along the recommended route acquired through the route search performed by the route searching unit 130, the route guidance unit 140 generates a route guidance figure and a voice guidance message including the information about a carpool lane as the vehicle travels. The route guidance figure is displayed on the monitor 2, and the voice guidance message is outputted from the audio speaker 4.

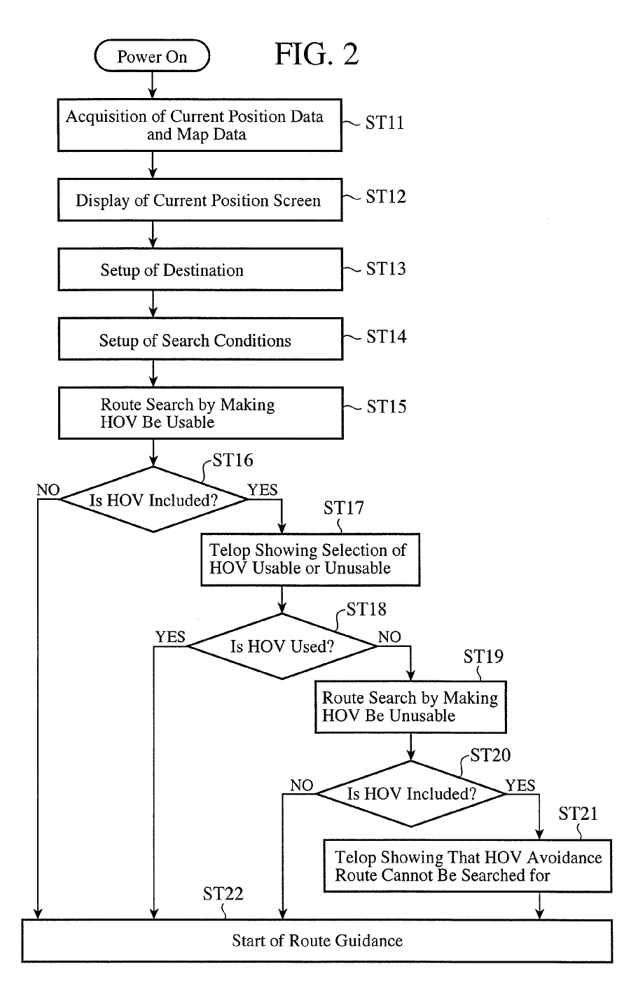

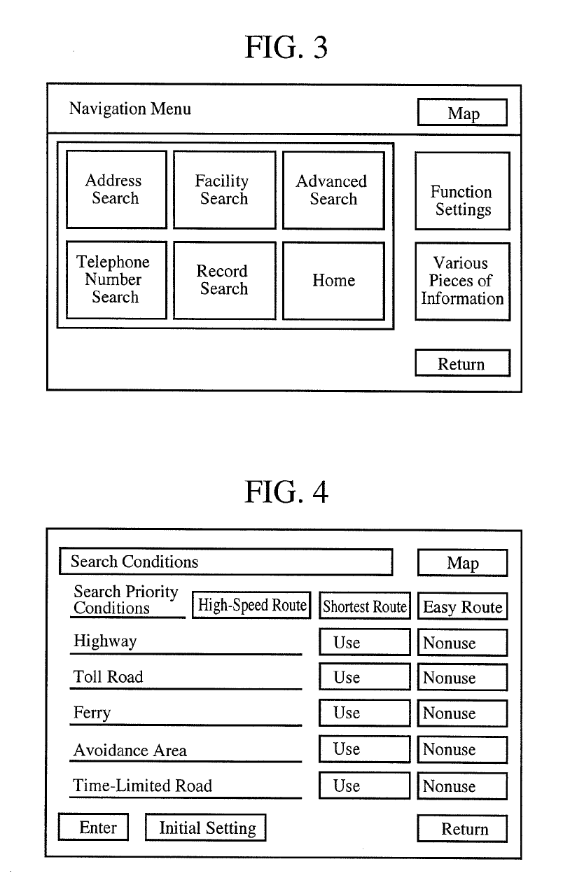

Next, the operation of the navigation apparatus which is constructed as mentioned above will be explained focusing on the route searching process of performing a search for a route including a car pool lane with reference to a flow chart shown in FIG. 2, and screen display examples shown in FIGS. 3 to 5. Although the navigation apparatus in accordance with Embodiment 1 of the present invention can display information about a car pool lane even when not setting up any destination to perform a search for a route, an example of the case of performing a route search and then displaying information about a car pool lane will be explained with reference to the flow chart shown in FIG. 2.

When the power supply of the navigation apparatus is switched on, the navigation apparatus acquires the current position data and map data first (step ST11). More specifically, the control unit 10 sends either the current position data acquired from the GPS receiver 13 or the current position data detected with autonomous navigation to the map matching unit 120. The disk drive unit 11 reads map data from the recording medium 11a set thereto, and stores them in the map data storage unit 12. The map matching unit 120 carries out a matching process of reading the map data from the map data storage unit 12, and superimposing the vehicle position mark on the map at a position corresponding to the current position data received from the control unit 10. The map data on which this matching process has been performed are sent to the map display unit 110. The map display unit 110 generates drawing data on the basis of the map data sent thereto from the map matching unit 120, and sends the drawing data to the monitor 2.

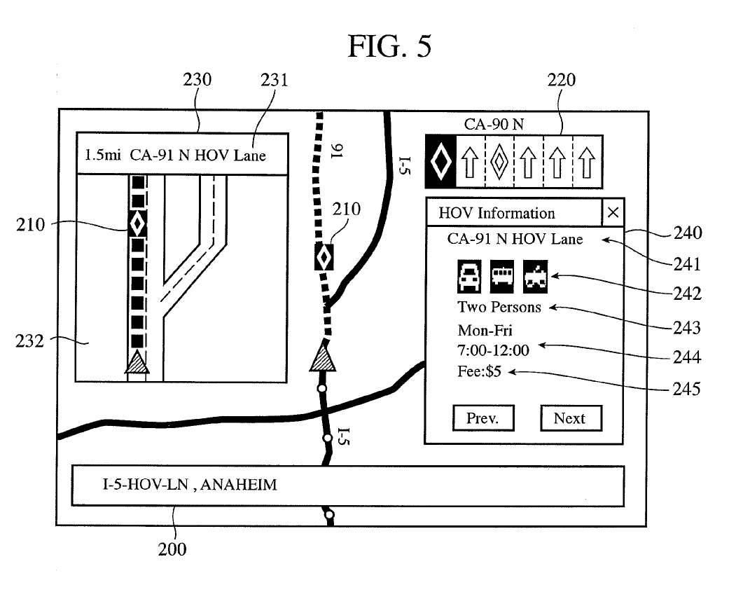

A display of a current position screen is then produced (step ST12). More specifically, the monitor 2 draws a map whose center corresponds to the current position of the vehicle on the basis of the drawing data received from the map display unit 110. Thereby, the map whose center corresponds to the current position of the vehicle, e.g., the map, as partially shown in FIG. 5, in which the vehicle position mark (a triangular mark) is at the center thereof is displayed, as the current position screen, on the monitor 2.

A setup of a destination is then performed (step ST13). More specifically, when the user performs an operation of instructing the navigation apparatus to set up a destination, the navigation apparatus displays a destination setup screen as shown in FIG. 3 on the monitor 2. The user uses the remote control 3 to set up a destination and a via-place on the map displayed on the monitor 2 by using an address search, a facility name search, a phone number search, or the like.

A setup of search conditions is then performed (step ST14). More specifically, when a setup of a destination is completed, the navigation apparatus displays a search condition setup screen as shown in FIG. 4 on the monitor 2. The user then sets up conditions for the route search which are displayed on the monitor 2 by using the remote control 3. The monitor 2 sends data showing the destination and the search conditions which are specified with the remote control 3 to the route searching unit 130 of the navigation unit 1.

The navigation apparatus then performs a route search by making car pool lanes (HOV) be usable (step ST15). More specifically, the route searching unit 130 searches for a route from the current position determined by the current position data received from the GPS receiver 13 via the control unit 10 to the destination set up in step ST13 according to the search conditions which are set up in step ST14.

The navigation apparatus then checks to see whether a car pool lane (HOV) is included in the route acquired through the route search in step ST15 (step ST16). When, in this step ST16, judging that no car pool lane (HOV) is included in the route, the navigation apparatus sends data showing the route acquired through the route search in step ST15 to the map display unit 110. As a result, the map display unit displays the searched-for route on the monitor 2. After that, the navigation apparatus advances the sequence to step ST22 and starts a route guidance.

When, in above-mentioned step ST16, judging that a car pool lane (HOV) is included in the route, the navigation apparatus then shows a telop for making the user select whether or not the user can use the car pool lane (HOV) (step ST17). The navigation apparatus then checks to see whether the user has made a selection of using the car pool lane (HOV) (step ST18). When, in this step ST18, judging that the user has made a selection of using the car pool lane (HOV), the navigation apparatus sends the data showing the route acquired through the route search in step ST15 to the map display unit 110, so that the map display unit displays the searched-for route on the monitor 2. After that, the navigation apparatus advances the sequence to step ST22 and starts a route guidance.

When, in above-mentioned step ST18, judging that the user has made a selection of not using the car pool lane (HOV), the navigation apparatus then carries out a route search again by making car pool lanes (HOV) be unusable (step ST19). The navigation apparatus then checks to see whether a car pool lane (HOV) is included in the route acquired through the route re-search in step ST19 (step ST20). The reason why the navigation apparatus checks to see whether a car pool lane (HOV) is included in the route acquired through the route re-search is that the navigation has to support a case in which the destination is set up as a point on a car pool lane and a case in which the current position is on a car pool lane.

When, in this step ST20, judging that no car pool lane (HOV) is included in the route acquired through the route re-search, the navigation apparatus sends data showing the route acquired through the route re-search in step ST19 to the map display unit 110, so that the map display unit displays the re-searched-for route on the monitor 2. After that, the navigation apparatus advances the sequence to step ST22 and starts a route guidance.

In contrast, when, in step ST20, judging that a carpool lane (HOV) is included in the route acquired through the route re-search, the navigation apparatus then shows a telop for warning the user that any car pool lane (HOV) avoidance route cannot be searched for (step ST21). In this case, the navigation apparatus sends the data showing the route acquired through the route re-search in step ST19 to the map display unit 110, so that the map display unit displays the re-searched-for route on the monitor 2. After that, the navigation apparatus advances the sequence to step ST22 and starts a route guidance.

In step ST22, the navigation apparatus starts a route guidance. More specifically, the route guidance unit 140 generates display data showing a guidance message on the basis of the route acquired through the searching in step ST15 or step ST19 and sends the display data to the monitor 2, and also generates audio data showing the guidance message and sends the audio data to the audio speaker 4. Thereby, while the guidance message is displayed on the monitor 2, the guidance message is outputted by voice from the audio speaker 4. After that, guidance messages corresponding to the environments which vary as the vehicle travels are outputted in turn.

In the route guidance, an example in which information about a car pool lane is displayed will be explained in some cases with reference to FIG. 5. FIG. 5 shows an example of display in a case in which the navigation apparatus is used in the U.S. where there exist car pool lanes at the present time. Each display as will be shown below is produced through control by the control unit 10.

First, during travel along a car pool lane or a road parallel to a car pool lane (a current link), the navigation apparatus displays the car pool lane name 200 of the road along which the vehicle is travelling irrespective of the presence or absence of the route acquired through the route search. Furthermore, in a case in which a car pool lane exists on a road in the traveling direction (a next road link), the navigation apparatus displays an icon 210 showing the car pool lane (referred to as an “HOV icon” from here on) as information about the car pool lane.

When the vehicle approaches a predetermined location during travel along the road, when, for example, the vehicle enters an area at a predetermined distance or less from the car pool lane, the navigation apparatus automatically displays lane information 220, a detailed figure 230, and HOV information 240 on the monitor 2 on the basis of the car pool lane data included in the map data acquired from the recording medium 11a. In this case, the navigation apparatus can be constructed in such a way as to provide the user with the lane information by voice in addition to the display of the lane information 220, the detailed figure 230, and the HOV information 240.

With the lane information 220, the position of the car pool lane within a plurality of lanes disposed on the road is displayed by the graphic of the HOV icon (a rhombus). In this case, a general purpose lane is expressed by an arrow. As a result, the user can know the total number of lanes and the position of the car pool lane (e.g., the how-manieth lane from the left side the car pool lane is).

The detailed figure 230 includes a map 232 showing the enlarged car pool lane in distinction from other lanes, as well as a name 231 of the next road link. The HOV icon 210 is added to the car pool lane. As a result, the user can recognize clearly that the car pool lane exists in the traveling direction.

As the HOV information 240, the name 241 of the car pool lane, the types 242 of vehicles which can use the car pool lane (e.g., a general vehicle, a bus, a truck, an emergency vehicle, a hybrid vehicle, a motorcycle, and so on), the number 243 of passengers which is required of the user to use the car pool lane, dates or days 244 of the week on which vehicles can use the car pool lane, and a time zone 244 in which vehicles can use the car pool lane, and the toll fee 245 of using the car pool lane are displayed. As a result, the user can know the details of the car pool lane.

The navigation apparatus can be constructed in such a way as to display the lane information 220 and the detailed figure 230 at all times after the vehicle enters the road including the car pool lane. As an alternative, the navigation apparatus can be constructed in such a way as to enable the user to make a setting about whether to provide a guidance about a car pool lane in advance by using the remote control 3, and, when the vehicle enters the road including the car pool lane, display the lane information 220 and the detailed figure 230 if the setting shows that the navigation apparatus should provide a guidance about a car pool lane. Also in either of the cases, the navigation apparatus can be constructed in such a way as to provide the user with the lane information by voice in addition to the display of the lane information 220 and the detailed figure 230.

In the above-mentioned example, the navigation apparatus is constructed in such a way as to, before entering a car pool lane or when a car pool lane exists in the next road link, display information about the car pool lane irrespective of the presence or absence of the route search. The navigation apparatus can be further constructed in such a way as to, also when a carpool lane exists in a link located beyond the next road link of the route acquired through the route search, display information about the car pool lane. The navigation apparatus can be further constructed in such a way as to, when the vehicle is travelling along a road corresponding a link in which there exists a gate intended for a carpool lane, display information about the car pool lane.

In the above-mentioned example, the navigation apparatus is constructed in such a way as to display a predetermined graphic as information about a car pool lane. The navigation apparatus can be further constructed in such a way as to change at least one of the color, the line type, or the shape of the graphic displayed according to, for example, an instruction from the remote control 3. In this case, the control unit 10 corresponds to a changing means of the present invention, and carries out a process of changing at least one of the color, the line type, or the shape of the graphic displayed according to an instruction from the remote control 3.

In the above-mentioned example, the control unit 10 is constructed in such away as to acquire map data including car pool lane data from the disk drive device 11 to which the storage medium 11a is mounted or the external memory 5. As an alternative, map data including car pool lane data can be distributed from an external road traffic data communications system, and the control unit can be constructed in such a way as to acquire the map data including the carpool lane data from the road information receiver 16 which has received the signal distributed from the road traffic data communications system.

As previously explained, when judging that a car pool lane exists on a road in the traveling direction on the basis of the carpool lane data, the navigation apparatus in accordance with Embodiment 1 of the present invention displays information about the carpool lane on the monitor 2 regardless of whether the navigation apparatus has performed a route search. Therefore, the navigation apparatus in accordance with Embodiment 1 of the present invention enables the user to recognize the appropriate information about the carpool lane. Therefore, the user can acquire the information about the car pool lane before the vehicle enters the car pool lane or at an earlier time than when the user will recognize a sign indicating the car pool lane visually. As a result, the user can do safe driving more quickly while keeping calm.

### INDUSTRIAL APPLICABILITY

As mentioned above, when judging that a car pool lane exists on a road in the traveling direction on the basis of map data and the current position, the navigation apparatus in accordance with the present invention displays information about the car pool lane so that the user can acquire the information about the car pool lane at an earlier time than when the use will recognize the car pool lane visually. Therefore, the navigation apparatus in accordance with the present invention is suitable for use in vehicles and the like which travel along a route in which a car pool lane exists.

1-12. (canceled)

13. A navigation apparatus including a map data acquiring means for acquiring map data including car pool lane data from a map recording medium, a current position determining means for determining a current position of a vehicle, a display unit for generating and displaying a map of an area surrounding the current position determined by said current position determining means on a basis of the map data acquired by said map data acquiring means, and a control unit for, when it is judged on a basis of the map data acquired by said map data acquiring means that either the current position determined by said current position determining means or a destination set up on the map displayed by said display unit is on a car pool lane, causing said display unit to display a warning indicating that a car pool lane avoidance route cannot be searched for, characterized in that:
when moving close to a predetermined location during travel along a road, on a basis of the car pool lane data included in the map data acquired by the map data acquiring means, said control unit automatically causes the display unit to display a detailed drawing showing lane information and a car pool lane in distinction from other lanes while enlarging the lane information and the car pool lane.

14. The navigation apparatus according to claim 13, characterized in that when entering the road including the car pool lane, on a basis of the car pool lane data included in the map data acquired by the map data acquiring means, the control unit always causes the display unit to display a detailed drawing showing lane information and the car pool lane in distinction from other lanes while enlarging the lane information and the car pool lane.

15. The navigation apparatus according to claim 13, characterized in that the navigation apparatus includes an input unit for setting up whether or not a guidance on a car pool lane is enabled, and, in a case in which said input unit has set up that a guidance on a car pool lane should be carried out, when entering the road including the car pool lane, on a basis of the car pool lane data included in the map data acquired by the map data acquiring means, the control unit automatically causes the display unit to display a detailed drawing showing lane information and the car pool lane in distinction from other lanes while enlarging the lane information and the car pool lane.

16. The navigation apparatus according to claim 13, characterized in that on a basis of the car pool lane data included in the map data acquired by the map data acquiring means, the control unit causes the display unit to display a position of the car pool lane in a plurality of lanes provided in the road.

17. The navigation apparatus according to claim 13, characterized in that on a basis of the car pool lane data included in the map data acquired by the map data acquiring means, the control unit causes the display unit to display the type of a car which can use the car pool lane.

18. The navigation apparatus according to claim 13, characterized in that on a basis of the car pool lane data included in the map data acquired by the map data acquiring means, the control unit causes the display unit to display a number of passengers which is required to use the car pool lane.

19. The navigation apparatus according to claim 13, characterized in that on a basis of the car pool lane data included in the map data acquired by the map data acquiring means, the control unit causes the display unit to display dates or days of the week on which the car pool lane can be used and a time zone in which the car pool lane can be used.

20. The navigation apparatus according to claim 13, characterized in that on a basis of the car pool lane data included in the map data acquired by the map data acquiring means, the control unit causes the display unit to display a toll of the car pool lane.

21. The navigation apparatus according to claim 13, characterized in that the navigation apparatus includes a changing means for, when a graphic is displayed on the display unit as the information about the car pool lane, changing at least one of a color, a line type, and a shape of the graphic.

22. The navigation apparatus according to claim 13, characterized in that the map data acquiring means acquires the map data including the car pool lane data from a road information receiver which receives road information sent thereto from outside the road information receiver.

23. The navigation apparatus according to claim 13, characterized in that the navigation apparatus includes a voice output unit for, when judging from the car pool lane data included in the map data that a car pool lane exists on a road in a traveling direction, the road being detected on a basis of both the map data acquired by the map data acquiring means and the current position determined by the current position determining means, outputting a guidance about the car pool lane by voice.
